(19) United States
(12) Patent Application Publication
(10) Pub. No.: US 2010/0242996 A1
(43) Pub. Date: Sep. 30, 2010

(54) AIRCRAFT COMPONENT WITH AERODYNAMIC SURFACE COATING

(75) Inventors: Colin John West, Bristol (GB); David Alistair Sutton, Bristol (GB); Jeremy Peter Bradley, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS OPERATIONS LIMITED, Bristol (GB)

(21) Appl. No.: 12/732,223

(22) Filed: Mar. 26, 2010

(30) Foreign Application Priority Data
Mar. 30, 2009 (GB) 0905396.8

(51) Int. Cl. B08B 7/00; B08B 3/04; B64C 21/02; B64C 3/00; B08B 5/00

(52) U.S. Cl. 134/16; 134/184; 134/105

(57) ABSTRACT

An aircraft component with an aerodynamic surface coating comprising a resilient foam with an array of open cells infused with a cleaning material such as a gel, paste or liquid. This prevents contaminants such as insects from adhering to the aircraft component. The resilient foam stores at least part of the impact energy of the contaminant, the cleaning material is released from the deformed foam so that the cleaning material at least partially coats the contaminant, and the foam springs back to eject the coated contaminant from the aircraft component.

### FIELD OF THE INVENTION

The present invention relates to an aircraft component with an aerodynamic surface coating—that is, a coating which is exposed to airflow when in flight.

### BACKGROUND OF THE INVENTION

Laminar wings generate a high degree of laminar flow and the separation point is positioned further aft than a conventional turbulent flow wing. Laminar flow wings have very low drag, but are particularly susceptible to surface imperfections in a narrow band at the leading edge of the wing.

The ability to maintain natural laminar flow over such wings for a significant period of operation has yet to be achieved. The major obstacles to maintaining natural laminar flow are impact damage to the surface profile and surface contamination.

To prevent surface contamination an anti fouling or self cleaning surface could be applied. However, most anti-contamination coatings have poor wear resistance and are not suitable for aircraft applications.

In “Summary of Past Experience in Natural Laminar Flow and Experimental Program for Resilient Leading Edge”, NASA CR-152276, B. H. Carmichael, May 1979, it was reported that the use of an elastic surface on a wing may be useful in the prevention of insect contamination. The idea, proposed by Dr F. X. Wortmann, was to find a surface which would constitute an elastic spring to store the impact energy for a short time before pushing the insect away from the surface. Although such a coating would push the insect away from the surface, it may still adhere to the surface particularly if the exoskeleton of the insect bursts on impact.

### SUMMARY OF THE INVENTION

A first aspect of the invention provides an aircraft component with an aerodynamic surface coating comprising a resilient foam with an array of open cells infused with a flowable cleaning material such as a gel, paste or liquid.

A second aspect of the invention provides a method of preventing a contaminant from adhering to an aircraft component, the method comprising storing at least part of the impact energy of the contaminant by deforming a resilient foam with an array of open cells infused with a cleaning material such as a gel, paste or liquid; releasing some of the cleaning material from the deformed foam so that the cleaning material at least partially coats the contaminant; the foam springing back to eject the coated contaminant from the aircraft component.

A system may optionally be provided for feeding the cleaning material into the foam, either between flights or during flight of the aircraft, for instance a tank storing the cleaning material; and one or more lines leading from the tank into the foam.

Means may be provided for heating the cleaning material in the foam, typically during flight of the aircraft, such as electric heaters or a series of ducts feeding hot air from an aircraft engine.

A problem with using silicone oil as the cleaning material is that such oils can contaminate other surfaces of the aircraft, making it difficult for paint to adhere to such surfaces. Also silicone oil has low viscosity so will have a tendency to flow too easily out of the foam and/or migrate within the foam under the force of gravity. Thus preferably the cleaning material comprises a high viscosity liquid, a gel or a paste.

Preferably one or more porous layers are provided on an outer face of the surface coating. This layer may comprise for instance a thin porous layer of non-linear PTFE, or a fabric. Typically at least one of the porous layers has an average pore diameter which is lower than an average cell diameter of the foam. This enables the layer(s) to prevent the cleaning material from flowing too easily out of the foam. Alternatively if the cells in the foam are sufficiently small then such porous layers may not be necessary.

The coating may be provided on a leading edge of an aircraft wing, particularly a laminar flow wing, on a shock bump, or on any other aerodynamic aircraft component which is prone to contamination with insects, ice or any other contaminant.

### BRIEF DESCRIPTION OF THE DRAWINGS

Embodiments of the invention will now be described with reference to the accompanying drawings, in which:

FIG. 1 is a cross section through the leading edge of a laminar flow wing;

FIG. 2 is an enlarged view of the leading edge;

FIG. 3 is a schematic cross-sectional view showing the fabric layer and part of the foam; and

FIGS. 4-6 show the leading edge before, during and after a collision with a particle.

### DETAILED DESCRIPTION OF EMBODIMENT(S)

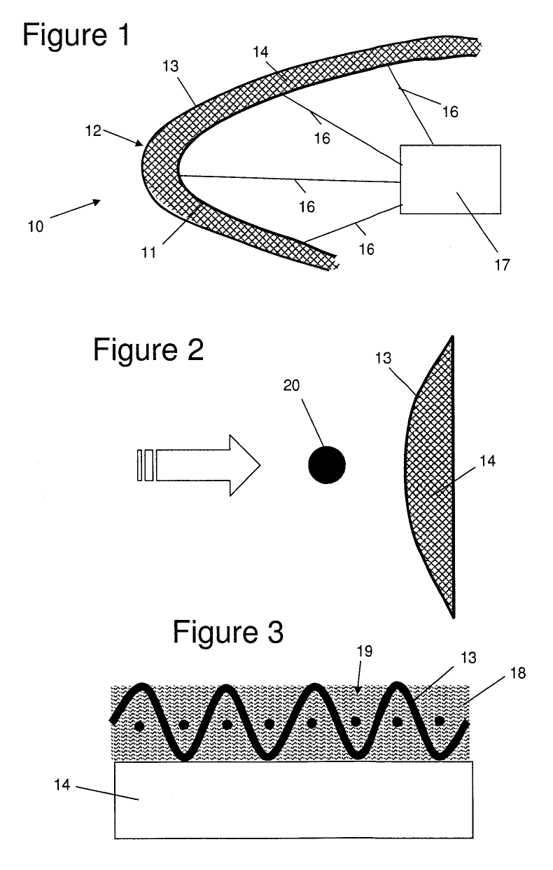

FIG. 1 is a cross sectional view of the leading edge 10 of a laminar flow wing. The leading edge 10 comprises a solid structure 11, typically made from carbon-fibre composite or aluminium, with a surface coating 12 bonded to the structure 11. Note that the drawings are not to scale so the thickness of the layer may vary from that shown. As shown in FIG. 2, the surface coating 12 comprises a porous fabric layer 13 which is backed by an elastomeric foam 14 comprising an array of open cells. A gel is pumped into the rear of the elastomeric foam from a tank 17 housed in the wing 2 via a set of lines 16.

The fabric 13 forms an aerodynamic external surface which is designed to minimise turbulent air flow over the leading edge. The fabric is formed from a low fricton material such as high strength Aramid, nylon, polyester, PTFE, Kevlar, Nomex or a blend of yarns. The fabric is woven or knitted in a manner that will allow local high deformation and recovery. The fabric has a high level of porosity and strength in order to allow passage of gel over controlled conditions. As shown in FIG. 3 the gel 18 infuses the fabric layer 13 and effectively smoothes the inter fibre areas 19 by partially filling them. Thus the gel gives the outer surface of the leading edge a relatively smooth profile, preferably with a maximum of 50 micron surface irregularity. This minimises the turbulent effects caused by imperfections on the surface of the leading edge.

Alternatively, instead of using a fabric layer 13, a smooth porous membrane made of non-linear PTFE may be applied to give the leading edge a closely toleranced surface profile. A specially tailored rough drag reducing “shark-skin” profiling may be given to such a porous membrane to further minimise drag.

The foam 14 is resilient to maintain its fitted thickness and profile against the airflow over the leading edge 10 of the wing 2, support the porous fabric layer 13, and maintain the required aerodynamic profile on the leading edge. The foam layer 14 may only be a few millimetres thick. For example, but not exclusively, the elastomeric foam may be made from EPDM (ethylene propylene diene M-class rubber), silicone rubber, fluorosilicone rubber, or polyurethane. The porous fabric 13 together with the foam backing 14 thus produces a hard-wearing surface profile with close dimensional tolerances.

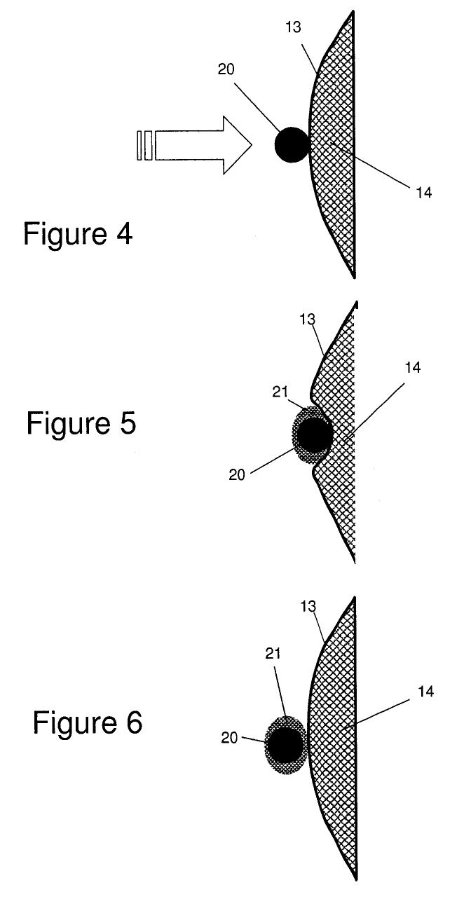

When the aircraft is in use, particularly during take-off and landing and up to an altitude of approximately 600 metres, contaminants such as insects or particles of ice impact the surface coating 12. Such impacts typically occur across a 90 mm band of the leading edge of the wing. As illustrated in FIGS. 4-6, when the surface of the outer fabric 13 is impacted with a contaminant particle 20, the fabric and the foam are deformed as they absorb the energy of the impact. As this occurs, some of the gel is forced through the porous fabric 13 onto its external surface, the pores in the fabric 13 being sized to limit the quantity of gel transferred. The resilient foam 14 then expands after impact to reform its original shape, thus exposing the gel coated contaminant particle 20 to the airflow. Moreover, the gel coating 21 reduces the friction on the underside of the contaminant's landing site, thus aiding the airflow to remove the contaminant particle 20 from the external surface of the fabric 13. Preferably, the gel is also formulated to dissolve common contaminants (such as insects) to further aid in their removal from the external aerodynamic surface.

To further discourage the adhesion of contaminant particles, the fabric 13 is preferably made from a material with a low surface energy. The fabric 13 must also be hard wearing to allow significant deformation during impact and it must be capable of recovery after impact. Materials such as, for example but not exclusively, PTFE, aramid, nylon and polyester are suitable. Both impact damage and surface contamination of the leading edge are thus minimised by the combination of the surface coating 12 and the gel.

The pumping of gel from the tank 17 to the foam 14 is activated by the aircraft computer control systems (not shown) to ensure that the supply of gel in the foam 14 is constantly replenished during flight. For example, if there is a build up of contamination on the wing, lift will decrease and the computer control systems will need to increase the pitch angle to maintain the desired flight altitude. Therefore, gel may be pumped automatically when the computer control systems increase the pitch angle of the aircraft. Gel pumping may also be automatically activated at altitudes between 0 and 600 metres. The tank 17 may be replenished when necessary, for example when refuelling the aircraft. The open cells allow the gel to infuse through the foam 14 so that it is evenly distributed at the foam surface. The gel also permeates from the foam 14 into the porous fabric 13 as shown in FIG. 3.

To prevent any build up of contamination on the external surface of the outer fabric 13, the gel evaporates from the external surface of the fabric without leaving significant amounts of residue. The gel must also be compatible with its surrounding materials, such as the solid structure 11 of the wing, so it must not corrode paint, composite or Aluminium. For example, but not exclusively, long chain alcohol gels, water-alcohol gels, solgels or colloidal water-alcohol pastes are suitable.

As well as providing the self-cleaning function described above, the infusion of gel has the effect of stiffening the foam layer 14. Optionally, the gel may have a freezing point at or above −30° C., to enable it to further stiffen the foam 14 during flight. Temperature effects can also be employed to alter the viscosity of the gel to adjust the properties of the foam. Heaters (not shown) may be provided to the rear of the foam 14 to ensure that the gel has the required lack of viscosity to pass through the pores in fabric 13 when the risk of impact with contaminant particles is greatest. For example, the heaters may be employed during take-off and landing, or simply when the aircraft changes its pitch at the start of a descent. The gel may also be formulated to resist the build up of ice on the wing 2.

Further porous layers may be draped over the porous fabric 13. These further layers may be of very fine yarn or if possible a porous membrane. Thus a series of layers may be built up with the pores become progressively smaller towards the outer surface. Thus the outer layer(s) will have more smoothness whilst the inner layer(s) while have superior mechanical properties such as strength.

The resilient foam layer 14 may improve the resistance of the wing to bird strikes. It may also improve the resistance of the wing to denting, for example, from the impact of hail stones which typically occurs across the same 90 mm band of the leading edge as insect impacts.

Although the invention has been described above with reference to one or more preferred embodiments, it will be appreciated that various changes or modifications may be made without departing from the scope of the invention as defined in the appended claims.

1. An aircraft component with an aerodynamic surface coating comprising a resilient foam with an array of open cells infused with a flowable cleaning material such as a gel, paste or liquid.

2. The aircraft component of claim 1 further comprising a system for feeding the cleaning material into the foam.

3. The aircraft component of claim 2 wherein the system comprises a tank storing the cleaning material; and one or more lines leading from the tank towards the foam.

4. The aircraft component of claim 1 further comprising means for heating the cleaning material in the foam.

5. The aircraft component of claim 1 wherein the flowable cleaning material comprises a gel or paste.

6. The aircraft component of claim 1 further comprising one or more porous layers on an outer face of the surface coating.

7. The aircraft component of claim 6 wherein at least one of the porous layers comprises a fabric.

8. The aircraft component of claim 6 wherein at least one of the porous layers has an average pore diameter which is lower than an average cell diameter of the foam.

9. The aircraft component of claim 1 wherein the component is a leading edge of an aircraft wing.

10. A method of preventing a contaminant from adhering to an aircraft component, the method comprising storing at least part of the impact energy of the contaminant by deforming a resilient foam with an array of open cells infused with a cleaning material such as a gel, paste or liquid; releasing some of the cleaning material from the deformed foam so that the cleaning material at least partially coats the contaminant; the foam springing back to eject the coated contaminant from the aircraft component.

11. The method of claim 10 further comprising feeding the cleaning material into the foam.

12. The method of claim 11 further comprising feeding the cleaning material into the foam during flight of the aircraft.

13. The method of claim 10 further comprising heating the cleaning material in the foam.

14. The method of claim 10 wherein the contaminant is an insect.
